(19) United States
(12) Patent Application Publication
(10) Pub. No.: US 2024/0386763 A1
(43) Pub. Date: Nov. 21, 2024

(54) Door Access Control Method Using a Wearable Device

(71) Applicant: I-Ting Shen, Tainan (TW)

(72) Inventor: I-Ting Shen, Tainan (TW)

(21) Appl. No.: 18/333,757

(22) Filed: Jun. 13, 2023

(30) Foreign Application Priority Data
May 17, 2023 (TW) 112118381

(51) Int. Cl. G07C 9/00

(52) U.S. Cl. CPC G07C 9/00182; G07C 2009/0019

(57) ABSTRACT

A door access control method includes using a wearable device to detect a physiological value of a concerned user wearing the wearable device. The wearable device matches with and is connected with a smart mobile device of the concerned user. When a lock APP installed on a smart mobile device of the concerned user identifies that the physiological value of the concerned user is abnormal, the smart mobile device automatically executes an emergency report and unlocking procedure, thereby informing a person that the concerned user is not feeling well. The lock switches to an unlocking state and remains in the unlocking state. The person can be informed of the execution of the emergency unlocking procedure at the first moment and can easily enter the room of the concerned user to provide help.

### BACKGROUND OF THE INVENTION

The present invention relates to a door access control method and, more particularly, to a door access control method which permits a concerned person not feeling well to automatically or manually retain a door lock in an unlocking state while informing another person.

In an aging society, it is a common problem that a solitary is injured or dies but on one finds out. Even if a person is aware of an uncommon event, such as a solitary neighbor has not gone out for several days, the person is possibly blocked by the locked door and, thus, cannot enter the solitary neighbor's house to provide assistance. For example, a solitary elder who moves with difficulty suddenly feels discomfort or falls at home, the solitary elder is not able to get up and go near the lock to unlock the door before calling out for help. If the solitary elder calls a relative, a friend or an ambulance, the called person cannot access the locked door, and the golden time may be wasted when breaking down the door is required.

### BRIEF SUMMARY OF THE INVENTION

In an aspect, the present invention provides a door access control method comprising:
installing a lock APP on a first smart mobile device of a manager;
installing the lock APP on a second smart mobile device of a concerned user, with the concerned user using the second smart mobile device to set a first preset unlocking information, with the concerned user wearing a wearable device which detects a physiological value of the concerned user, wherein the wearable device matches with and is connected with the second smart mobile device of the concerned user;
using the lock APP installed on the first smart mobile device to obtain management authority of the lock;
using the first smart mobile device to authorize authority of execution of an emergency report and unlocking procedure on the lock to the second smart mobile device;
wherein when the lock APP installed on the second smart mobile device identifies that the physiological value of the concerned user is normal, the second smart mobile device does not execute the emergency report and unlocking procedure, wherein when the lock APP installed on the second smart mobile device identifies that the physiological value of the concerned user is abnormal, the second smart mobile device executes the emergency report and unlocking procedure and executes a reporting procedure sending a report to the manager, the lock switches to an unlocking state and remains in the unlocking state, and wherein the lock restores the locking state after the lock is opened.

The physiological value of the concerned user can be instantly detected via a wearable device and transmitted to the lock APP installed on the smart mobile device of the concerned user. When the lock APP installed on the smart mobile device of the concerned user identifies the physiological value is abnormal, the lock APP installed on the smart mobile device of the concerned user automatically executes that emergency report and unlocking procedure. Thus, the health condition of the concerned user can be detected automatically, and assistance can be provided instantly, providing excellent convenience.

Furthermore, when the concerned user executes the emergency report and unlocking procedure, the lock (such as a door lock) can remain in the unlocking state without movement of the concerned user who is not feeling well or is unable to move smoothly, providing excellent convenience.

Through use of the wearable device matched or tied with the smart mobile device of the concerned user, the emergency report and unlocking procedure can be automatically executed when an abnormal physiological value is detected. The concerned user needs not to input a real-time unlocking information, which assures execution of the emergency report and unlocking procedure which retains the lock in the unlocking state, thereby providing safety use.

In an example, the physiological value includes a blood oxygen level of the concerned user. The lock APP installed on the second smart mobile device identifies the physiological value of the concerned user is abnormal when the blood oxygen level of the concerned user is lower than 80%. The lock APP installed on the second smart mobile device identifies the physiological value of the concerned user is normal when the blood oxygen level of the concerned user is not lower than 80%.

In an example, the physiological value includes a body temperature of the concerned user. The lock APP installed on the second smart mobile device identifies the physiological value of the concerned user is abnormal when the body temperature of the concerned user is not lower than 41° C. or not higher than 35° C. The lock APP installed on the second smart mobile device identifies the physiological value of the concerned user is normal when the body temperature of the concerned user is 35° C.-41° C.

In an example, the physiological value includes a heart rate of the concerned user. The lock APP installed on the second smart mobile device identifies the physiological value of the concerned user is abnormal when the heart rate of the concerned user is not higher than 30 beats per minute. The lock APP installed on the second smart mobile device identifies the physiological value of the concerned user is normal when the heart rate of the concerned user is higher than 30 beats per minute.

In an example, the concerned user uses the second smart mobile device to register a username. The manager uses the username to authorize the authority of execution of the emergency report and unlocking procedure and a normal unlocking procedure to the second smart mobile device. When the concerned user uses the interface of the lock APP installed on the second smart mobile device to execute the normal unlocking procedure, a real-time unlocking information is inputted into the second smart mobile device. The lock remains in the locking state when the real-time unlocking information does not match with the first preset unlocking information. The lock switches to the unlocking state when the real-time unlocking information matches with the first preset unlocking information. A countdown of an unlocking time of the lock is executed after the lock switches to the unlocking state. The lock switches back to the locking state after the countdown is over or the lock is opened.

The concerned user is permitted to unlock the lock through the normal unlocking procedure, such that the concerned user can normally access the house or the room without interrupting the manager or the report receiver.

In an example, an interface of the lock APP installed on the first smart mobile device guides setting of a second preset unlocking information. When the manager uses the interface of the lock APP installed on the first smart mobile device to execute a normal unlocking procedure, a real-time unlocking information is inputted into the second smart mobile device. The lock remains in the locking state when the real-time unlocking information inputted into the first smart mobile device does not match with the second preset unlocking information. The lock switches to the unlocking state when the real-time unlocking information inputted into the first smart mobile device matches with the second preset unlocking information. A countdown of an unlocking time of the lock is executed after the lock switches to the unlocking state. The lock switches back to the locking state after the countdown is over or the lock is opened.

In an example, the door access control method further comprises:
installing the lock APP on a third smart mobile device of a normal user, registering a username of the normal user, and setting a third preset unlocking information; and
using the first smart mobile device and the username of the normal user to authorize the authority of execution of a normal unlocking procedure of the lock to the third smart mobile device,
wherein when the normal user uses an interface of the lock APP installed on the third smart mobile device to execute the normal unlocking procedure, the third smart mobile device is used to input a real-time unlocking information, wherein the lock remains in the locking state when the real-time unlocking information inputted into the third smart mobile device does not match with the third preset unlocking information, wherein the lock switches to the unlocking state when the real-time unlocking information matches inputted into the third smart mobile device with the third preset unlocking information, wherein a countdown of an unlocking time of the lock is executed after the lock switches to the unlocking state, and wherein the lock switches back to the locking state after the countdown is over or the lock is opened.

The manager can selectively authorize a normal user and/or a concerned user, such that the normal user can only execute the normal unlocking procedure, whereas the concerned user can execute the normal unlocking procedure and the emergency report and unlocking procedure. Thus, it is more convenient for the manager to manage a plurality of locks and associated persons.

In an example, when the report receiver does not respond to the report, the report is repeatedly sent to the report receiver. The reporting procedure is terminated when the report receiver responds to the report.

When the concerned user executes the emergency report and unlocking procedure, the manager or a preset report receiver will receive the report. Thus, the situation of the concerned user requiring help can be reported at the first moment.

In an example, when the lock APP installed on the second smart mobile device executes the reporting procedure, the interface of the lock APP installed on the first smart mobile device shows a message associated with the report. The report receiver uses the interface of the lock APP installed on the first smart mobile device to respond to the report and to terminate the reporting procedure.

In an example, when the concerned user executes the emergency report and unlocking procedure via an interface of the lock APP installed on the second smart mobile device, the lock APP installed on the second smart mobile device is used to input a real-time unlocking information. When the real-time unlocking information does not match with the first preset unlocking information, the lock remains in the locking state. When the real-time unlocking information matches with the first preset unlocking information, the second smart mobile device executes a reporting procedure to report to the manager, the lock is switched to the unlocking state and remains in the unlocking state, and the lock restores the locking state after the lock is opened.

When a concerned user needs help, the emergency report and unlocking procedure can be executed to keep the lock at the location of the concerned user in the unlocking state, and the lock will not restore the locking state unless the lock is opened. Thus, any person can open the lock to check the situation of the concerned user.

In another aspect, a door access control method using a wearable device comprises:
installing a lock APP on a first smart mobile device of a concerned user and setting a report receiver;
using the lock APP installed on the first smart mobile device to obtain management authority of the lock, permitting the first smart mobile device to execute an emergency report and unlocking procedure on the lock, with the concerned user wearing a wearable device which detects a physiological value of the concerned user, wherein the wearable device matches with and is connected with the first smart mobile device; wherein when the lock APP installed on the first smart mobile device identifies the physiological value of the concerned user is normal, the first smart mobile device does not execute the emergency report and unlocking procedure, wherein when the lock APP installed on the first smart mobile device identifies the physiological value of the concerned user is abnormal, the first smart mobile device executes the emergency report and unlocking procedure and executes a reporting procedure sending a report to the report receiver, the lock switches to an unlocking state and remains in the unlocking state, and wherein the lock restores the locking state after the lock is opened.

When the concerned user executes the emergency report and unlocking procedure, the lock (such as a door lock) can remain in the unlocking state without movement of the concerned user who is not feeling well or is unable to move smoothly, providing excellent convenience.

The physiological value of the concerned user can be instantly detected via a wearable device and transmitted to the lock APP installed on the smart mobile device of the concerned user. When the lock APP installed on the smart mobile device of the concerned user identifies the physiological value is abnormal, the lock APP installed on the smart mobile device of the concerned user automatically executes that emergency report and unlocking procedure. Thus, the health condition of the concerned user can be detected automatically, and assistance can be provided instantly, providing excellent convenience. Furthermore, through use of the wearable device matched or tied with the smart mobile device of the concerned user, the emergency report and unlocking procedure can be automatically executed when an abnormal physiological value is detected. The concerned user needs not to input a real-time unlocking information, which assures execution of the emergency report and unlocking procedure which retains the lock in the unlocking state, thereby providing safety use.

In an example, the physiological value includes a blood oxygen level of the concerned user. The lock APP installed on the first smart mobile device identifies the physiological value of the concerned user is abnormal when the blood oxygen level of the concerned user is lower than 80%. The lock APP installed on the first smart mobile device identifies the physiological value of the concerned user is normal when the blood oxygen level of the concerned user is not lower than 80%.

In an example, the physiological value includes a body temperature of the concerned user. The lock APP installed on the first smart mobile device identifies the physiological value of the concerned user is abnormal when the body temperature of the concerned user is not lower than 41° C. or not higher than 35° C. The lock APP installed on the first smart mobile device identifies the physiological value of the concerned user is normal when the body temperature of the concerned user is 35° C.-41° C.

In an example, the physiological value includes a heart rate of the concerned user. The lock APP installed on the first smart mobile device identifies the physiological value of the concerned user is abnormal when the heart rate of the concerned user is not higher than 30 beats per minute. The lock APP installed on the first smart mobile device identifies the physiological value of the concerned user is normal when the heart rate of the concerned user is higher than 30 beats per minute.

In an example, the lock APP installed on the first smart mobile device of the concerned user requests setting of a first preset unlocking information. When the concerned user uses the interface of the lock APP installed on the first smart mobile device to execute a normal unlocking procedure, a real-time unlocking information is inputted into the first smart mobile device. The lock remains in the locking state when the real-time unlocking information does not match with the first preset unlocking information. The lock switches to the unlocking state when the real-time unlocking information matches with the first preset unlocking information. A countdown of an unlocking time of the lock is executed after the lock switches to the unlocking state. The lock switches back to the locking state after the countdown is over or the lock is opened.

The concerned user is permitted to unlock the lock through the normal unlocking procedure, such that the concerned user can normally access the house or the room without interrupting the manager or the report receiver.

In an example, when the report receiver does not respond to the report, the report is repeatedly sent to the report receiver. The reporting procedure is terminated when the report receiver responds to the report.

In an example, the lock APP is installed on a second smart mobile device held by the report receiver. When the concerned user executes the reporting procedure, a message of the report is displayed on an interface of the lock APP installed on the second smart mobile device. The report receiver responds to the report via the interface of the lock APP installed on the second smart mobile device to terminate the reporting procedure.

In an example, the report receiver uses the lock APP installed on the second smart mobile device to register a username. The concerned user uses the username to set the report receiver and sending information of the setting of the report receiver to the lock APP installed on the second smart mobile device. The setting of the report receiver is successfully set only when the report receiver uses the lock APP installed on the second smart mobile device to accept the setting of the report receiver.

In an example, the lock APP installed on the first smart mobile device of the concerned user requests setting of a first preset unlocking information. When the concerned user executes the emergency report and unlocking procedure via an interface of the lock APP installed on the first smart mobile device, the lock APP installed on the first smart mobile device is used to input a real-time unlocking information. When the real-time unlocking information does not match with the first preset unlocking information, the lock remains in the locking state. When the real-time unlocking information matches with the first preset unlocking information, the first smart mobile device executes a reporting procedure to report to the report receiver, the lock is switched to the unlocking state and remains in the unlocking state. The lock restores the locking state after the lock is opened.

When a concerned user needs help, the emergency report and unlocking procedure can be executed to keep the lock at the location of the concerned user in the unlocking state, and the lock will not restore the locking state unless the lock is opened. Thus, any person can open the lock to check the situation of the concerned user.

The present invention will become clearer in light of the following detailed description of illustrative embodiments of this invention described in connection with the drawings.

### DESCRIPTION OF THE DRAWINGS

FIG. 1 is a schematic flowchart illustrating a door access control method using a wearable device of a first embodiment according to the present invention.

FIG. 2 a schematic flowchart illustrating a door access control method using a wearable device of a second embodiment according to the present invention.

### DETAILED DESCRIPTION OF THE INVENTION

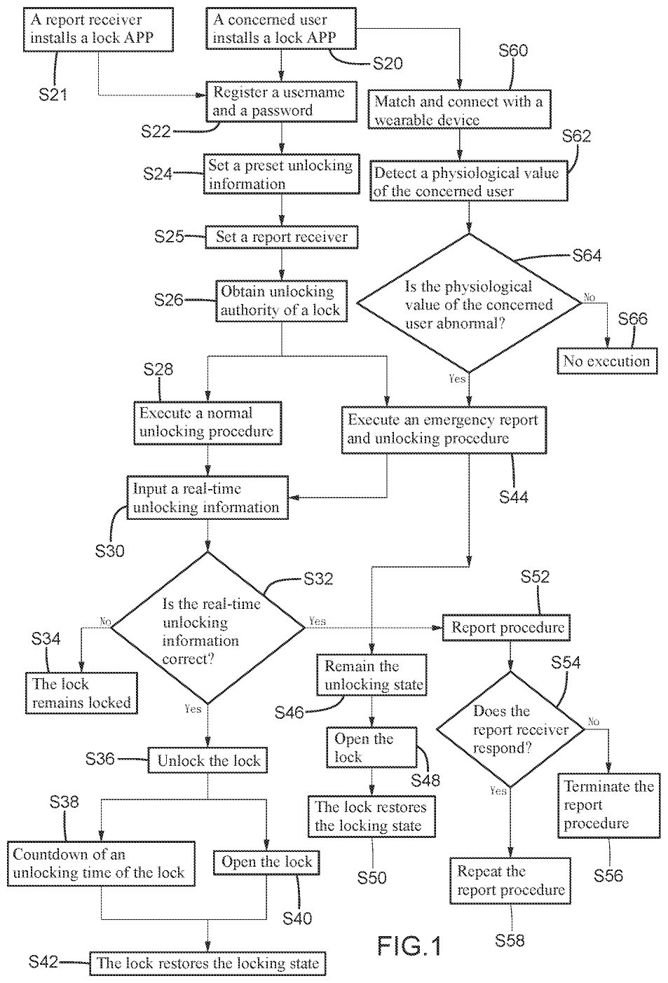

The present invention relates to a door access system for a solitary (hereinafter referred to as “concerned user”) who is not feeling well, in a poor health condition, and/or old. With reference to FIG. 1 showing a door access control method using a wearable device of a first embodiment according to the present invention, the door access system generally requires cooperation of some hardware equipment including but limited to at least one lock, a smart mobile device (such as a smartphone) held by the concerned user, a wearable device worn by the concerned user, and a smart mobile device (such as a smartphone) held by a report receiver. The wearable device may detect a physiological value of the concerned user, including but not limited to at least one of the heart rate, blood oxygen level, body temperature, etc. The wearable device may be, but not limited to, a smart watch capable of detecting the above physiological value and, thus, can be worn on a wrist of the concerned user for a long period of time. The lock is set to a normally locking state. For example, in a case that the lock is a door lock mounted on a door and set to a normally locking state, when the locking state is not released, the closed door cannot be opened by operating the door lock from the outer side.

A lock application (APP) is installed on the smart mobile device of the concerned user (step S20), and the lock APP is also installed on the smart mobile device of the report receiver (step S21). Specifically, since using the smart mobile device of the concerned user to obtain the management authority of the lock requires execution of the lock APP, the lock APP must be installed on the smart mobile device of the concerned user beforehand. Preferably, the lock APP is also installed on the smart mobile device of the report receiver predetermined to receive the report from the concerned user, which can be used to proceed with the reporting procedure (step S52).

In an embodiment, when the lock APP is installed on either of the smart mobile device of the concerned user and the smart mobile device of the concerned user for the first time, an interface of the lock APP will guide the concerned user and/or the report receiver to register a username and a password (step S22). The username may be characters, numbers, symbols, or a combination thereof set by himself or herself. The password may be characters, numbers, symbols, or a combination thereof set by himself or herself. Alternatively, the password may be a biological feature of the holder of the smart mobile device. For example, the password set by the lock APP installed on the smart mobile device of the concerned user is the biological feature, such as the fingerprint feature, the facial feature, the iris feature, etc., of the concerned user.

After the concerned user has registered the username and the password on his or her smart mobile device, the lock APP installed on the smart mobile device of the concerned user guides the concerned user to input an unlocking information as a first preset unlocking information (step S24). Specifically, the first preset unlocking information may be characters, numbers, symbols, or a combination thereof. Alternatively, the unlocking information may be a biological feature, such as the fingerprint feature, the facial feature, the iris feature, etc. It is noted that after the smart mobile device of the report receiver has finished registration of the username and the password, the procedure of setting the first preset unlocking information can be skipped, because there is no need to use the smart mobile device of the report receiver to unlock the lock.

After the smart mobile device of the concerned user has finished the procedure of setting the first preset unlocking information, the lock APP further guides the concerned user to set a report receiver (step S25). Specifically, the report receiver may be, but not limited to, a friend, a relative, a landlord, a social worker, etc. trusted by the concerned user. In a non-restrictive example, the lock APP may be installed on the smart mobile device of the report receiver. Thus, given that the concerned user knows the username of the report receiver, the username of the report receiver can be inputted through the interface of the lock APP installed on the smart mobile device of the concerned user to thereby connect with the lock APP installed on the smart mobile device of the report receiver via Wi-Fi, Global System for Mobile Communication, or Bluetooth. After the report receiver presses an “agree” icon or “accept” icon on the interface of the lock APP installed on the smart mobile device of the report receiver, the lock APP installed on the smart mobile device of the concerned user completes setting of the report receiver.

More specifically, after the lock APP is installed on the smart mobile device of the report receiver, when the concerned user inputs a username associated with the report receiver, the smart mobile device of the concerned user can be connected with the smart mobile device of a user associated with the inputted username via a wireless network, such as Wi-Fi, Global System for Mobile Communication, or Bluetooth, and the interface of the lock APP installed on the smart mobile device of the user associated with the username guides the user to choose whether to accept the invitation of becoming a report receiver of the concerned user. The user becomes the report receiver of the concerned user only when the user agrees.

It is worth mentioning that setting of the report receiver can be achieved by an approach other than the lock APP installed on the smart mobile device to receive the information associated with the concerned user. For example, the report receiver may be a social worker, and the report receiver setting procedure may be achieved by the concerned user inputting the mobile phone number of the social worker. In this case, the report receiver set by the concerned user cannot deny.

After the smart mobile device of the concerned user finishes setting of the report receiver, the lock APP is connected with a lock within the communication range of the smart mobile device of the concerned user and obtains the management authority of the lock after matching (step S26).

Specifically, the lock may include, but not limited to, two matching buttons, and the lock may be paired with a card which carries a specific serial number. When the lock APP installed on the smart mobile device of the concerned user is matching with the lock, the interface of the lock APP requests adding of a lock to be managed, and the two matching buttons of the lock are pressed for a longer time (such as 5 seconds), permitting the smart mobile device of the concerned user to search the lock. When the smart mobile device of the concerned user finds the lock, the lock APP guides the concerned user to input the serial number on the card. The smart mobile device of the concerned user can obtain the management authority of the lock only when the inputted serial number is correct. Thus, the smart mobile device of the concerned user obtains the authority of execution of an emergency report and unlocking procedure and a normal unlocking procedure.

For example, in a case that the smart mobile device of the concerned user obtains a hardware identification serial number of the lock, in subsequent communication between the smart mobile device of the concerned user and the lock, the lock may compare the hardware identification serial number transmitted by the smart mobile device of the concerned user with its own hardware identification serial number to identify whether the smart phone device connected with the lock has the management authority.

When the lock APP installed on the smart mobile device of the concerned user executes a normal unlocking procedure (step S28), a real-time unlocking information is inputted into the smart mobile device of the concerned user (step S30). The lock remains in the locking state (step S34) when the real-time unlocking information is determined to be incorrect at step S32. The lock is unlocked (step S36) when the real-time unlocking information is determined to be correct at step S32.

For example, in a case that the first preset unlocking information is a fingerprint of the concerned user, when the concerned user uses the smart mobile device of the concerned user to execute the normal unlocking procedure, the lock APP installed on the smart mobile device of the concerned user requests input of a fingerprint as the real-time unlocking information which is compared with the first preset unlocking information by the smart mobile device of the concerned user. When the real-time unlocking information does match with the first preset unlocking information, the smart mobile device of the concerned user does not output any command to the lock, and the lock remains locked. On the other hand, when the real-time unlocking information matches with the first preset unlocking information, the smart mobile device of the concerned user outputs an unlocking command to the lock. The unlocking command may include, but not limited to, a hardware identification serial number associated with the lock. After the lock receives the unlocking command, the lock is unlocked when the hardware identification serial number sent by the smart mobile device of the concerned user is correct. On the other hand, the unlocking command will not be executed when the hardware identification serial number sent by the smart mobile device of the concerned user is incorrect, the lock remains locked.

After the lock is unlocked (switches to the unlocking state), countdown of an unlocking time (a period of time during which the lock remains in the unlocking state) is executed (step S38). When the countdown is over, the lock restores the locking state (step S42). Alternatively, the lock restores the locking state (step S42) after the door is opened (step S40).

Specifically, to prevent the concerned user from forgetting to switch the lock to the locking state after unlocking, after the concerned user unlocks the lock through the normal unlocking procedure, the lock will proceed the countdown procedure (such as 15 seconds). Thus, after the lock has been unlocked for 15 seconds, the lock is automatically locked again and remains in the locking state until the next unlocking operation.

In another case, given the lock is unlocked, when the lock is opened during the unlocking period (for example, the lock is opened at the fifth second), the lock will automatically switch to the locking state and will remain in the locking state until the next unlocking operation. For example, the lock is a door lock mounted on a door, after the door lock is unlocked and is operated to open the door, the door lock will automatically switch to the locking state if the door is closed again, preventing the door from being opened.

Furthermore, the concerned user wears the wearable device on his or her body, such as wears a smart watch on the wrist. Then, the concerned user matches the wearable device with the smart mobile device of the concerned user and creates a connection between the wearable device and the smart mobile device of the concerned user (step S60). The wearable device detects the physiological value of the concerned user. The smart mobile device of the concerned user obtains the physiological value via the lock APP installed on the wearable device.

The wearable device continuously monitors the physiological value of the concerned user. The lock APP installed on the smart mobile device can obtain and analyze the physiological value of the concerned user every few seconds via the wearable device. Thus, the lock APP installed on the smart mobile device of the concerned user can initially judge whether the body of the concerned user is normal through analysis of the physiological value.

For example, the wearable device detects the heart rate of the concerned user. Since the heart rate fluctuation is large, a preferred approach is using the minimal heart rate to judge whether the body of the concerned user is normal. The heart rate of an ordinary person in sleep is not lower than 30 beats per minute. Thus, the physiological value is defined as abnormal when the heart rate is not higher than 30 beats per minute, and the physiological value is defined as normal when the heart rate is higher than 30 beats per minute.

In an embodiment, the wearable device can detect the blood oxygen level of the concerned user. The blood oxygen level normally should be at 95%. When the blood oxygen level is lower than 90%, it is deemed as hypoxemia. Thus, the physiological value can be defined as abnormal when the blood oxygen level is lower than 85%.

In another embodiment, the wearable device can detect the body temperature of the concerned user. The physiological value is defined as normal when the body temperature of the concerned user is 35° C.-41° C. The physiological value is defined as abnormal when the body temperature of the concerned user is not lower than 41° C. or not higher than 35° C.

After the lock APP installed on the smart mobile device of the concerned user obtains the physiological value via the wearable device, the physiological value is judged at step S64. When the physiological value is normal, the emergency report and unlocking procedure is not executed (step S66). When the physiological value is abnormal, the emergency report and unlocking procedure is executed (step S44).

In a case that the physiological value detected by the wearable device is the heart rate, the heart rate not higher than 30 beats per minute is set as abnormal. The lock APP installed on the smart mobile device of the concerned user obtains the instant heart rate of the concerned user via the wearable device and identifies whether the heart rate is abnormal. When the heart rate of the concerned user is higher than 30 beats per minute, it is determined that the physiological value is normal, and the emergency report and unlocking procedure is not automatically executed. When the heart rate of the concerned user is not higher than 30 beats per minute, it is determined that the physiological value is abnormal, and the emergency report and unlocking procedure is automatically executed.

In another case that the physiological value detected by the wearable device is the oxygen blood level, the lock APP installed on the smart mobile device of the concerned user will not execute the emergency report and unlocking procedure when the oxygen blood level is higher than 85%. When the oxygen blood level is not higher than 85%, the lock APP installed on the smart mobile device of the concerned user will automatically execute the emergency report and unlocking procedure. In a further case that the physiological value detected by the wearable device is the body temperature, the lock APP installed on the smart mobile device of the concerned user will not execute the emergency report and unlocking procedure when the body temperature is 35° C.-41° C. The lock APP installed on the smart mobile device of the concerned user will automatically execute the emergency report and unlocking procedure when the body temperature is not lower than 41° C. or not higher than 35° C.

When the lock APP installed on the smart mobile device of the concerned user automatically executes the emergency report and unlocking procedure based on the determination of the abnormal physiological value, the lock APP installed on the smart mobile device of the concerned user will directly send an unlocking command to the lock. The lock receiving the unlocking command switches to an unlocking state and remains in the unlocking state (step S46) when the unlocking command is correct, and a reporting procedure is directly executed (step S52). Namely, when the physiological value of the concerned user is abnormal, the lock APP installed on the smart mobile device of the concerned user will not request input of a real-time unlocking information.

Aside from execution of the emergency report and unlocking procedure due to detection of an abnormal physiological value, the concerned user may also manually execute the emergency report and unlocking procedure through the interface of the lock APP installed on the smart mobile device of the concerned user. When the concerned user executes the emergency report and unlocking procedure through the interface of the lock APP installed on the smart mobile device of the concerned user (step S44), the lock APP installed on the smart mobile device of the concerned user requests input of a real-time unlocking information (step S30). The lock remains in the locking state (step S34) and the reporting procedure (step S52) is not executed when the real-time unlocking information is determined to be incorrect at step S32. The lock is unlocked (step S36) and the reporting procedure (step S52) is executed when the real-time unlocking information is determined to be correct at step S32.

The interface of the lock APP may present an icon representing the emergency report and unlocking procedure. When execution of the emergency report and unlocking procedure is required, the concerned user may press the icon for 3 seconds, and the lock APP installed on the smart mobile device of the concerned user executes the emergency report and unlocking procedure. It is worth mentioning that the setting of pressing the icon representing the emergency report and unlocking procedure for a long period of time is to avoid touching the icon by mistake. The time of pressing the icon can be adjusted according to needs. For example, the time of pressing the icon can be between 3-10 seconds.

It is noted that no matter the emergency report and unlocking procedure is executed due to an abnormal physiological value or manual execution by the concerned user, execution of the emergency report and unlocking procedure means that the concerned user extremely needs assistance from other persons and even cannot move near the lock to manually unlock the lock. Therefore, when the lock remains in the unlocking state due to execution of the emergency report and unlocking procedure, the lock will remain in the unlocking state if the lock is not opened.

No matter the emergency report and unlocking procedure is executed due to an abnormal physiological value or manual execution by the concerned user, the lock restores its locking state (step S50) only after the lock in the unlocking state is opened (step S48).

For example, the lock is a door lock. When the door is opened while the lock remains in the unlocking state, the concerned user who is not feeling well can be found. Thus, after the door is opened, the door lock automatically switches to the locking state and remains in the locking state until the door lock is unlocked again.

No matter the emergency report and unlocking procedure is executed due to an abnormal physiological value or manual execution by the concerned user, while the lock remains in the unlocking state due to execution of the emergency report and unlocking procedure, the lock APP installed on the smart mobile device of the concerned user will automatically execute a reporting procedure in which the smart mobile device of the concerned user reports execution of the emergency report and unlocking procedure to the smart mobile device of the report receiver (step S52). For example, a message associated with execution of the emergency report and unlocking procedure is shown on, e.g., the screen of the smart mobile device of the report receiver by the lock APP installed on the smart mobile device of the report receiver.

No matter the emergency report and unlocking procedure is executed due to an abnormal physiological value or manual execution by the concerned user, after the lock APP installed on the smart mobile device of the concerned user sends the report of execution of the emergency report and unlocking procedure to the smart mobile device of the report receiver, the report is sent repeatedly (step S56) when the report receiver does not respond. On the other hand, when the report receiver responds to the report, the report procedure is terminated (step S58).

In a workable embodiment, after the smart mobile device of the report receiver receives the report from the lock APP installed on the smart mobile device of the concerned user, the report receiver can press an icon on the interface of the lock APP installed on the smart mobile device of the report receiver, which activates the smart mobile device of the report receiver to send a command back to the smart mobile device of the concerned user via the network, which, in turn, activates the lock APP installed on the smart mobile device of the concerned user to reach a determination that the report receiver has received the message, and the reporting procedure is terminated.

In another workable embodiment, after the smart mobile device of the report receiver receives the report from the lock APP installed on the smart mobile device of the concerned user, instead of pressing an icon on the interface of the lock APP installed on the smart mobile device of the report receiver, the smart mobile device of the report receiver starts to remind the report receiver of the incoming message through vibration or sound. After the report receiver clicks an icon on the interface of the lock APP installed on the smart mobile device of the report receiver, the vibration or sound is stopped.

Furthermore, in a case that the mobile phone number of the report receiver is required for the reporting procedure, when the concerned user executes the reporting procedure, the smart mobile device of the concerned user directly dials the mobile phone number of the report receiver. After the connection with the smart mobile device of the report receiver is established, the lock APP installed on the smart mobile device of the concerned user determines that it is a response from the report receiver and, thus, terminates the reporting procedure. On the other hand, when the smart mobile device of the report receiver is not connected or does not answer the call, the lock APP installed on the smart mobile device of the concerned user determines that the report receiver does not respond and, thus, repeats reporting (such as repeatedly dial the mobile phone number).

The technical features of the first embodiment of the door access control method capable of sending an emergency report according to the present invention has been set forth in connection with FIG. 1, an example will be set forth to assist in more understanding of the first embodiment of the door access control method capable of sending an emergency report according to the present invention. Assuming a tenant (a concerned user) aged 75 years lives alone in a house owned by a landlord (a report receiver). An electronic door lock (the lock) is installed on a door of the house. The lock APP is installed on the smart mobile device of the landlord, and the landlord has a username but has not yet obtained the management authority of the door lock, such that the smart mobile device of the landlord cannot be used to unlock the door lock. After the tenant moves in the house, the lock APP is installed on the smart mobile device of the tenant, and the management authority of the door lock can be obtained through the procedure disclosed in the first embodiment of the door access control method capable of sending an emergency report according to the present invention. The tenant sets the username of the landlord as the report receiver. Furthermore, the tenant wears a smart watch which can detect the heart rate. The lock APP installed on the smart mobile device of the tenant can obtain the instant heart rate of the tenant through the smart watch. Thus, when the tenant wishes to enter the house, the lock APP installed on the smart mobile device of the tenant can be used to execute the normal unlocking procedure to normally unlock the door lock and then open the door. In this case, the landlord will not receive any report or interruption.

In a case that the tenant in the house is not feeling well and the heart rate is lower than 30 beats per minute, after the lock APP installed on the smart mobile device of the tenant automatically executes the emergency report and unlocking procedure, the door lock of the house will remain in the unlocking state permitting any person (a policeman, an ambulance man, the landlord, etc.) to open the door and enter the house. Then, the lock APP installed on the smart mobile device of the tenant sends a message associated with execution of the emergency report and unlocking procedure to the lock APP installed on the landlord via a network. The message will be sent repeatedly until the landlord responds, such that the landlord can be aware of the situation of the tenant and can provide assistance to the tenant, such as go to the house to help the tenant or call an ambulance.

In a case that the heart rate detected by the lock APP installed on the smart mobile device of the tenant is not lower than 30 beats per minute, when the tenant is not feeling well, the tenant can use the interface of the lock APP installed on the smart mobile device of the tenant to execute the emergency report and unlocking procedure, such that the door lock of the house of the tenant is unlocked and remains in the unlocking state. The lock APP installed on the smart mobile device of the tenant reports the execution of the emergency report and unlocking procedure to the lock APP installed on the smart mobile device of the landlord via a wireless network. Thus, the landlord can be aware of the situation of the tenant at the first moment and can provide assistance to the tenant more rapidly, such as go to the house to help the tenant or call an ambulance.

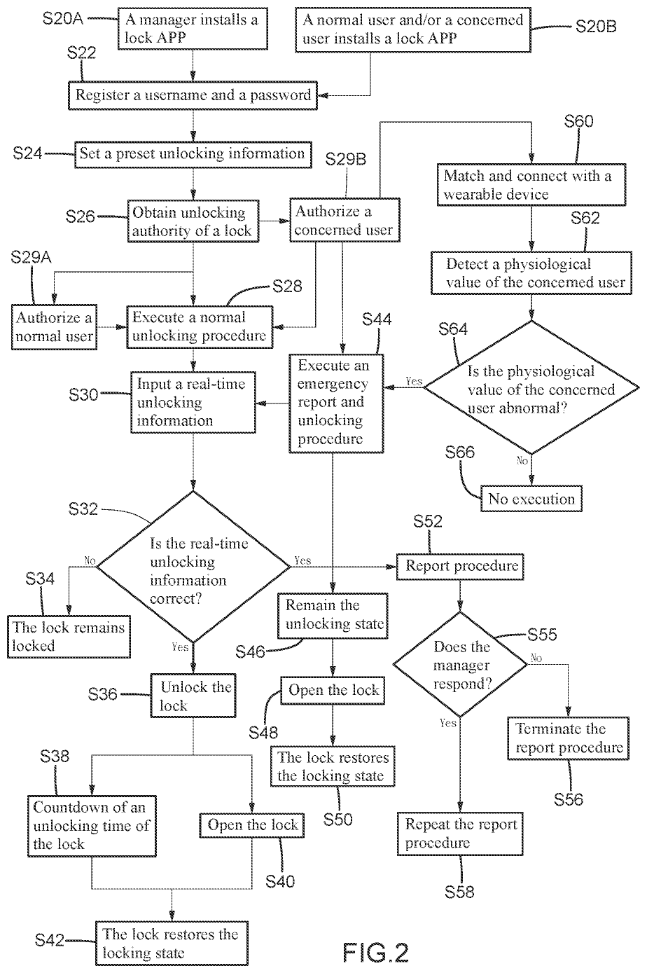

The first embodiment of the door access control method using a wearable device according to the present invention shown in FIG. 1 is an embodiment where the manager of the lock is the concerned user. Nevertheless, the door access control method according to the present invention may be used in other situations. FIG. 2 shows a second embodiment of the door access control method using a wearable device according to the present invention. The second embodiment is more suitable to a manger who manages at least one normal user and/or at least one concerned user. In this situation, the manager must firstly obtain the management authority of a lock and then authorize the management authority to each normal user and each concerned user.

Specifically, a lock APP is installed on a smart mobile device held by the manager (step S20A). The lock APP can be executed by the manager to obtain the management authority of the lock.

In an embodiment, when the smart mobile device of the manager executes the lock APP for the first time, the interface of the lock APP will guide the manager and/or the report receiver to register a username and a password (step S22). The username may be characters, numbers, symbols, or a combination thereof set by himself or herself. The password may be characters, numbers, symbols, or a combination thereof set by himself or herself. Alternatively, the password may be a biological feature of the holder of the smart mobile device. For example, the password set by the lock APP installed on the smart mobile device of the manager is the biological feature, such as the fingerprint feature, the facial feature, the iris feature, etc., of the manager.

After the manager has registered the username and the password on his or her smart mobile device, the lock APP installed on the smart mobile device of the manager guides the manager to input an unlocking information as a second preset unlocking information (step S24). Specifically, the second preset unlocking information may be characters, numbers, symbols, or a combination thereof. Alternatively, the unlocking information may be a biological feature, such as the fingerprint feature, the facial feature, the iris feature, etc.

After the smart mobile device of the manager finishes setting of the second preset unlocking information, the lock APP is connected with a lock within the communication range of the smart mobile device of the manager and obtains the management authority of the lock after matching (step S26).

Specifically, the lock may include, but not limited to, two matching buttons, and the lock may be paired with a card which carries a specific serial number. When the lock APP installed on the smart mobile device of the manager is matching with the lock, the interface of the lock APP requests adding of a lock to be managed, and the two matching buttons of the lock are pressed for a longer time (such as 5 seconds), such that the smart mobile device of the manager can search the lock. When the smart mobile device of the manager finds the lock, the lock APP guides the manager to input the serial number on the card. The smart mobile device of the manager can obtain the management authority of the lock only when the inputted serial number is correct. For example, in a case that the smart mobile device of the manager obtains a hardware identification serial number of the lock, in subsequent communication between the smart mobile device of the manager and the lock, the lock may compare the hardware identification serial number sent by the smart mobile device of the manager with its own hardware identification serial number to identify whether the smart phone device connected with the lock has the management authority.

When the lock APP installed on the smart mobile device of the manager executes a normal unlocking procedure (step S28), a real-time unlocking information is inputted into the smart mobile device of the manager under the request of the lock APP installed on the smart mobile device of the manager (step S30). The lock remains in the locking state (step S34) when the real-time unlocking information is determined to be incorrect at step S32. The lock is unlocked (step S36) when the real-time unlocking information is determined to be correct at step S32.

For example, in a case that the second preset unlocking information is a fingerprint of the manager, when the manager uses the smart mobile device of the manager to execute the normal unlocking procedure, the lock APP installed on the smart mobile device of the manager requests input of a fingerprint as the real-time unlocking information which is compared with the second preset unlocking information by the smart mobile device of the manager. When the real-time unlocking information does not match with the second preset unlocking information, the smart mobile device of the manager does not output any command to the lock, and the lock remains locked.

On the other hand, when the real-time unlocking information matches with the second preset unlocking information, the smart mobile device of the manager within the wireless communication range of the lock (such as via Bluetooth) outputs an unlocking command to the lock. The unlocking command may include, but not limited to, a hardware identification serial number associated with the lock. After the lock receives the unlocking command, the lock is unlocked when the hardware identification serial number sent by the smart mobile device of the manager is correct. On the other hand, the unlocking command will not be executed when the hardware identification serial number sent by the smart mobile device of the manager is incorrect, the lock remains locked.

After the lock is unlocked, countdown of an unlocking time (a period of time during which the lock remains in an unlocking state) is executed (step S38). When the countdown is over, the lock restores the locking state (step S42). Alternatively, the lock restores the locking state (step S42) after the lock is opened (step S40).

Specifically, to prevent from forgetting to switch the lock back to the locking state after unlocking, after the manager unlocks the lock through the normal unlocking procedure, the lock will proceed the countdown procedure (such as 15 seconds). Thus, after the lock is unlocked for 15 seconds, the lock is automatically locked again and remains in the locking state until the next unlocking operation.

In another case, given the lock is unlocked, when the lock is opened during the unlocking period (for example, the lock is opened at the fifth second), the lock will automatically switch to the locking state and will remain in the locking state until the next unlocking operation. For example, the lock is a door lock mounted on a door, after the door lock is unlocked and is operated to open the door, the door lock will automatically switch to the locking state when the door is closed again, preventing the door from being opened.

Aside from the normal unlocking operation through use of the smart mobile device of the manager, the manager may also use the smart mobile device of the manager to authorize at least one normal user (step S29A) and/or at least one concerned user (step S29B). In a case that the manager intends to authorize a normal user, the lock APP is firstly installed on a smart mobile device of the normal user, and the normal user needs to register a username and a password via an interface of the lock APP installed on the smart mobile device of the normal user (see step S22). The registered username and the password are required when logging in lock APP installed on the smart mobile device of the normal user. Then, a third preset unlocking information is set by the normal user under guidance by the lock APP installed on the smart mobile device of the normal user (see step S24). For example, the normal user uses the lock APP installed on the smart mobile device of the normal user to input his or her fingerprint (which is different from the unlocking information inputted by the manager) as the third preset unlocking information.

After the manger obtains the username of the normal user, the manager uses the interface of the lock APP installed on the smart mobile device of the manager to input the username of the normal user to be authorized, and then selects a to-be-authorized lock whose authority is to be authorized to the normal user. It is noted that a manger may have the manage authority of a plurality of locks. The lock APP installed on the smart mobile device of the manager sends an authorizing packet (which may be encrypted) through a network to the lock APP installed on the smart mobile device of the normal user. The authorizing packet may include, but not limited to, the hardware identification information of the lock and the type of authorization (a normal user or a concerned user). Thus, the lock APP installed on the smart mobile device of the normal user obtains the authority to execute the normal unlocking procedure of the lock with the specific hardware identification serial number (which is decided by the type of authority).

When the lock APP installed on the smart mobile device of the normal user executes a normal unlocking procedure (step S28), the lock APP installed on the smart mobile device of the normal user requests input of a real-time unlocking information (step S30). The lock remains in the locking state (step S34) when the real-time unlocking information is determined to be incorrect at step S32. The lock is unlocked (step S36) when the real-time unlocking information is determined to be correct at step S32. Similar to the normal unlocking procedure executed by the manager, after the lock is unlocked, countdown of the unlocking time (a period of time during which the lock remains in an unlocking state) is executed (step S38). In a case that the lock is not opened during the countdown period (such as 15 seconds), the lock automatically restores the locking state (step S42). Alternatively, when the lock is opened during the countdown period, the lock also automatically restores the locking state (step S42). It is noted that since the normal user does not obtain the authority of a concerned user, the normal user cannot execute the emergency report and unlocking procedure.

In another case that the manager intends to authorize a concerned user, the lock APP is firstly installed on a smart mobile device of the concerned user (step S20B), and the concerned user needs to register a username and a password via an interface of the lock APP installed on the smart mobile device of the concerned user (see step S22). The registered username and the password are required when logging in lock APP installed on the smart mobile device of the concerned user. Then, a first preset unlocking information is set by the concerned user under guidance by the lock APP installed on the smart mobile device of the concerned user (see step S24). For example, the concerned user uses the lock APP installed on the smart mobile device of the concerned user to input his or her fingerprint (which is different from the unlocking information inputted by the manager) as the first preset unlocking information.

After the manger obtains the username of the concerned user, the manager uses the interface of the lock APP installed on the smart mobile device of the manager to input the username of the concerned user to be authorized, and then selects a to-be-authorized lock whose authority is to be authorized to the concerned user. It is noted that a manger may have the manage authority of a plurality of locks. The lock APP installed on the smart mobile device of the manager sends an authorizing packet (which may be encrypted) through a network to the lock APP installed on the smart mobile device of the concerned user. The authorizing packet may include, but not limited to, the hardware identification information the lock and the type of authorization (a normal user or a concerned user). Thus, the lock APP installed on the smart mobile device of the concerned user obtains the authority to execute the normal unlocking procedure of the lock (with the specific hardware identification serial number) and the emergency report and unlocking procedure, which is decided by the type of authority.

When the lock APP installed on the smart mobile device of the concerned user executes a normal unlocking procedure (step S28), the lock APP installed on the smart mobile device of the concerned user requests input of a real-time unlocking information (step S30). The lock remains in the locking state (step S34) when the real-time unlocking information is determined to be incorrect at step S32. The lock is unlocked (step S36) when the real-time unlocking information is determined to be correct at step S32. Similar to the normal unlocking procedure executed by the manager, after the lock is unlocked, countdown of the unlocking time (a period of time during which the lock remains in the unlocking state) is executed (step S38). In a case that the lock is not opened during the countdown period (such as 15 seconds), the lock automatically restores the locking state (step S42). Alternatively, when the lock is opened during the countdown period, the lock also automatically restores the locking state (step S42).

After the smart mobile device of the concerned user obtains the authority of the normal unlocking procedure and the emergency report and unlocking procedure, the concerned user may wear a wearable device which is matched and connected with the smart mobile device of the concerned user (step S60). The wearable device detects the physiological value of the concerned user. The lock APP installed on the smart mobile device of the concerned user obtains the instant physiological value of the concerned user via the wearable device (step S62).

After the lock APP installed on the smart mobile device of the concerned user obtains the instant physiological value of the concerned user via the wearable device, the lock APP installed on the smart mobile device of the concerned user identifies whether the physiological value of the concerned user is normal at step S64. The smart mobile device of the concerned user does not execute the emergency report and unlocking procedure (step S66) when the physiological value is normal. When the lock APP installed on the smart mobile device of the concerned user determines that the physiological value of the concerned user is abnormal at step S64, the smart mobile device of the concerned user automatically executes the emergency report and unlocking procedure (step S44).

For example, in a case that the physiological value detected by the wearable device is the heart rate of the concerned user, the lock APP installed on the smart mobile device of the concerned user obtains the instant heart rate of the concerned user via the wearable device. Then, the lock APP installed on the smart mobile device of the concerned user identifies whether the heart rate of the concerned user is abnormal. When the lock APP installed on the smart mobile device of the concerned user identifies that the heart rate of the concerned user is higher than 30 beats per minute, the heart rate is determined as normal, and the emergency report and unlocking procedure will not be executed automatically. When the lock APP installed on the smart mobile device of the concerned user identifies that the heart rate of the concerned user is not higher than 30 beats per minute, the heart rate is determined as abnormal, and the emergency report and unlocking procedure will be executed automatically.

Likewise, in a case that the physiological value is the blood oxygen level of the concerned user, when the blood oxygen level is higher than 85%, the lock APP installed on the smart mobile device of the concerned user will not execute the emergency report and unlocking procedure. When the blood oxygen level is not higher than 85%, the lock APP installed on the smart mobile device of the concerned user will automatically execute the emergency report and unlocking procedure. Likewise, in another case that the physiological value is the body temperature of the concerned user, when the body temperature is 35° C.-41° C., the lock APP installed on the smart mobile device of the concerned user will not execute the emergency report and unlocking procedure. When the body temperature is not lower than 41° C. or not higher than 35° C., the lock APP installed on the smart mobile device of the concerned user will automatically execute the emergency report and unlocking procedure.

When the lock APP installed on the smart mobile device of the concerned user automatically executes the emergency report and unlocking procedure based on determination of abnormality of the physiological value of the concerned user, the lock APP installed on the smart mobile device of the concerned user will directly send an unlocking command to the lock and will directly execute a reporting procedure (step S52). When the lock identifies that the received unlocking command is correct, the lock switches to the unlocking state and remains in the unlocking state (step S64). Namely, when the physiological value of the concerned user is abnormal, the lock APP installed on the smart mobile device of the concerned user will not request the concerned user to input a real-time unlocking information.

Aside from execution of the emergency report and unlocking procedure based on detection of an abnormal physiological value, the concerned user may manually execute the emergency report and unlocking procedure via the interface of the lock APP installed on the smart mobile device of the concerned user.

For example, the interface of the lock APP may present an icon representing the emergency report and unlocking procedure. When execution of the emergency report and unlocking procedure is required, the concerned user may press the icon for 3 seconds, and the lock APP installed on the smart mobile device of the concerned user executes the emergency report and unlocking procedure. It is worth mentioning that the setting of pressing the icon representing the emergency report and unlocking procedure for a long period of time is to avoid touching the icon by mistake. The time of pressing the icon can be adjusted according to needs. For example, the time of pressing the icon can be between 3-10 seconds.

In comparison with execution of the emergency report and unlocking procedure based on detection of the abnormal physiological value, when the concerned user feels the body is in an abnormal state but the lock APP installed on the smart mobile device of the concerned user does not detect abnormality of the physiological value, the concerned user may manually execute the emergency report and unlocking procedure.

When the concerned user manually executes the emergency report and unlocking procedure, the lock APP requests input of a real-time unlocking information (step S30). The real-time unlocking information is identified at step S32. When the real-time unlocking information is incorrect, the lock remains in the locking state (step S34). When the real-time unlocking information is correct, the lock remains in the unlocking state (step S46), and a reporting procedure is executed (step S52).

No matter the emergency report and unlocking procedure is executed due to an abnormal physiological value or manual execution by the concerned user, execution of the emergency report and unlocking procedure means that the concerned user extremely needs assistance from other persons and even cannot move near the lock to manually unlock the lock. Therefore, when the lock remains in the unlocking state under execution of the emergency report and unlocking procedure, the lock will remain in the unlocking state if the lock is not opened.

No matter the emergency report and unlocking procedure is executed due to an abnormal physiological value or manual execution by the concerned user, when the lock is opened while the lock is in the unlocking state (step S48), the lock restores its locking state (step S50).

For example, the lock is a door lock. When the door is opened while the lock remains in the unlocking state, the concerned user who is not feeling well can be found. Thus, after the door is opened, the door lock automatically switches to the locking state and remains in the locking state until the door lock is unlocked again.

Furthermore, no matter the emergency report and unlocking procedure is executed due to an abnormal physiological value or manual execution by the concerned user, while the lock remains in the unlocking state due to execution of the emergency report and unlocking procedure, the lock APP installed on the smart mobile device of the concerned user will automatically execute a reporting procedure in which the smart mobile device of the concerned user reports execution of the emergency report and unlocking procedure to the smart mobile device of the report receiver (step S52). For example, a message associated with execution of the emergency report and unlocking procedure is shown on, e.g., the screen of the smart mobile device of the report receiver by the lock APP installed on the smart mobile device of the report receiver.

No matter the emergency report and unlocking procedure is executed due to an abnormal physiological value or manual execution by the concerned user, after the lock APP installed on the smart mobile device of the concerned user sends the report of execution of the emergency report and unlocking procedure to the smart mobile device of the report receiver, the report is sent again (step S56) when the report receiver does not respond. On the other hand, when the report receiver responds to the report, the report procedure is terminated (step S58).

In a workable embodiment, after the smart mobile device of the report receiver receives the report from the lock APP installed on the smart mobile device of the concerned user, the report receiver can press an icon on the interface of the lock APP installed on the smart mobile device of the report receiver, which activates the smart mobile device of the report receiver to send a command back to the smart mobile device of the concerned user via the network, which, in turn, activates the lock APP installed on the smart mobile device of the concerned user to reach a determination that the report receiver has received the message, and the reporting procedure is terminated.

In another workable embodiment, after the smart mobile device of the report receiver receives the report from the lock APP installed on the smart mobile device of the concerned user, instead of pressing an icon on the interface of the lock APP installed on the smart mobile device of the report receiver, the smart mobile device of the report receiver starts to remind the report receiver of the incoming message through vibration or sound. After the report receiver clicks an icon on the interface of the lock APP installed on the smart mobile device of the report receiver, the vibration or sound is stopped.

The technical features of the second embodiment of the door access control method capable of sending an emergency report according to the present invention has been set forth in connection with FIG. 2, an example will be set forth to assist in more understanding of the second embodiment of the door access control method capable of sending an emergency report according to the present invention. Assuming a manager of a health preservation village owns management authority of door locks of a plurality of rooms. Furthermore, the manager authorizes the authority of execution of the emergency report and unlocking procedure and the normal unlocking procedure to residents of some rooms and authorizes the authority of execution of normal unlocking procedure to workers of other rooms, such that each worker can execute the normal unlocking procedure to unlock a locked room whose authority has been granted to the worker. The resident of each room having the authority of the emergency report and unlocking procedure wears a smart watch that can detect the heart rate, and the smart watch of each resident is matched and connected with the smart mobile device of the resident. Thus, the lock APP installed on the smart mobile device of each resident can obtain the instant heart rate (the physiological value) of the resident via the smart watch thereof. The resident of each room can enter his or her own room through execution of the normal unlocking procedure to unlock the door lock of his or her own room. When the smart watch of a resident in a room detects that heart rate of the resident is not higher than 30 beats per minute, the lock APP installed on the smart mobile device of the resident automatically executes the emergency report and unlocking procedure. The lock APP installed on the smart mobile device of the manager displays execution of the emergency report and unlocking procedure by the resident of the associated room. Thus, the manager can know who executes the emergency report and unlocking procedure at the first moment and take necessary actions accordingly.

In a case that abnormality of the physiological value is not detected by the lock APP installed on the smart mobile device of the resident, when the resident is not feeling well, the resident can use the interface of the lock APP installed on the smart mobile device of the resident to manually execute the emergency report and unlocking procedure, such that the door lock of the room of the resident is unlocked and remains in the unlocking state. The lock APP installed on the smart mobile device of the resident reports the execution of the emergency report and unlocking procedure to the lock APP installed on the smart mobile device of the manager via a wireless network. Thus, the manager can be aware of the situation of the resident at the first moment and can provide assistance to the resident more rapidly, such as go to the house to help the tenant or call an ambulance.

In each embodiment of the present invention, when a concerned user needs help, the emergency report and unlocking procedure can be executed to keep the lock at the location of the concerned user in the unlocking state, and the lock will not restore the locking state unless the lock is opened. Thus, any person can open the lock to check the situation of the concerned user.

In each embodiment, when the concerned user executes the emergency report and unlocking procedure, the lock (such as a door lock) can remain in the unlocking state without movement of the concerned user who is not feeling well or is unable to move smoothly, providing excellent convenience.

In each embodiment, when the concerned user executes the emergency report and unlocking procedure, the manager or a preset report receiver will receive the report. Thus, the situation of the concerned user requiring help can be reported at the first moment.

In each embodiment, the physiological value of the concerned user can be instantly detected via a wearable device and transmitted to the lock APP installed on the smart mobile device of the concerned user. When the lock APP installed on the smart mobile device of the concerned user identifies the physiological value is abnormal, the lock APP installed on the smart mobile device of the concerned user automatically executes that emergency report and unlocking procedure. Thus, the health condition of the concerned user can be detected automatically, and assistance can be provided instantly, providing excellent convenience.

In each embodiment, through use of the wearable device matched or tied with the smart mobile device of the concerned user, the emergency report and unlocking procedure can be automatically executed when an abnormal physiological value is detected. The concerned user needs not to input a real-time unlocking information, which assures execution of the emergency report and unlocking procedure which retains the lock in the unlocking state, thereby providing safety use.

In the second embodiment, the manager can selectively authorize a normal user and/or a concerned user, such that the normal user can only execute the normal unlocking procedure, whereas the concerned user can execute the normal unlocking procedure and the emergency report and unlocking procedure. Thus, it is more convenient for the manager to manage a plurality of locks and associated persons.

The concerned user is permitted to unlock the lock through the normal unlocking procedure, such that the concerned user can normally access the house or the room without interrupting the manager or the report receiver.

Now that the basic teachings of the present invention have been explained, many extensions and variations will be obvious to one having ordinary skill in the art. For example, the physiological value is not limited to the heart rate, body temperature, and blood oxygen level mentioned in the specification. Other physiological values may be used. Furthermore, plural physiological values can be used, such as detecting the heart rate and the blood oxygen level at the same time, and the emergency report and unlocking procedure will be automatically executed when either of the heart rate and the blood oxygen level is abnormal. Furthermore, the physiological value for determining the abnormality can be adjusted to be more strict or loose according to needs.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A door access control method comprising:
installing a lock APP on a first smart mobile device of a manager;
installing the lock APP on a second smart mobile device of a concerned user, with the concerned user using the second smart mobile device to set a first preset unlocking information, with the concerned user wearing a wearable device which detects a physiological value of the concerned user, wherein the wearable device matches with and is connected with the second smart mobile device of the concerned user;
using the lock APP installed on the first smart mobile device to obtain management authority of the lock;
using the first smart mobile device to authorize authority of execution of an emergency report and unlocking procedure on the lock to the second smart mobile device;
wherein when the lock APP installed on the second smart mobile device identifies that the physiological value of the concerned user is normal, the second smart mobile device does not execute the emergency report and unlocking procedure,
wherein when the lock APP installed on the second smart mobile device identifies that the physiological value of the concerned user is abnormal, the second smart mobile device executes the emergency report and unlocking procedure and executes a reporting procedure sending a report to the manager, the lock switches to an unlocking state and remains in the unlocking state, and wherein the lock restores the locking state after the lock is opened.

2. The door access control method as claimed in claim 1, wherein the physiological value includes a blood oxygen level of the concerned user, wherein the lock APP installed on the second smart mobile device identifies the physiological value of the concerned user is abnormal when the blood oxygen level of the concerned user is lower than 80%, and wherein the lock APP installed on the second smart mobile device identifies the physiological value of the concerned user is normal when the blood oxygen level of the concerned user is not lower than 80%.

3. The door access control method as claimed in claim 1, wherein the physiological value includes a body temperature of the concerned user, wherein the lock APP installed on the second smart mobile device identifies the physiological value of the concerned user is abnormal when the body temperature of the concerned user is not lower than 41° C. or not higher than 35° C., and wherein the lock APP installed on the second smart mobile device identifies the physiological value of the concerned user is normal when the body temperature of the concerned user is 35° C.-41° C.

4. The door access control method as claimed in claim 1, wherein the physiological value includes a heart rate of the concerned user, wherein the lock APP installed on the second smart mobile device identifies the physiological value of the concerned user is abnormal when the heart rate of the concerned user is not higher than 30 beats per minute, and wherein the lock APP installed on the second smart mobile device identifies the physiological value of the concerned user is normal when the heart rate of the concerned user is higher than 30 beats per minute.

5. The door access control method as claimed in claim 1, wherein the concerned user uses the second smart mobile device to register a username, wherein the manager uses the username to authorize the authority of execution of the emergency report and unlocking procedure and a normal unlocking procedure to the second smart mobile device, wherein when the concerned user uses the interface of the lock APP installed on the second smart mobile device to execute the normal unlocking procedure, a real-time unlocking information is inputted into the second smart mobile device, wherein the lock remains in the locking state when the real-time unlocking information does not match with the first preset unlocking information, wherein the lock switches to the unlocking state when the real-time unlocking information matches with the first preset unlocking information, wherein a countdown of an unlocking time of the lock is executed after the lock switches to the unlocking state, and wherein the lock switches back to the locking state after the countdown is over or the lock is opened.

6. The door access control method as claimed in claim 1, wherein an interface of the lock APP installed on the first smart mobile device guides setting of a second preset unlocking information, wherein when the manager uses the interface of the lock APP installed on the first smart mobile device to execute a normal unlocking procedure, a real-time unlocking information is inputted into the second smart mobile device, wherein the lock remains in the locking state when the real-time unlocking information inputted into the first smart mobile device does not match with the second preset unlocking information, wherein the lock switches to the unlocking state when the real-time unlocking information inputted into the first smart mobile device matches with the second preset unlocking information, wherein a countdown of an unlocking time of the lock is executed after the lock switches to the unlocking state, and wherein the lock switches back to the locking state after the countdown is over or the lock is opened.

7. The door access control method as claimed in claim 1, further comprising:
installing the lock APP on a third smart mobile device of a normal user, registering a username of the normal user, and setting a third preset unlocking information; and
using the first smart mobile device and the username of the normal user to authorize the authority of execution of a normal unlocking procedure of the lock to the third smart mobile device,
wherein when the normal user uses an interface of the lock APP installed on the third smart mobile device to execute the normal unlocking procedure, the third smart mobile device is used to input a real-time unlocking information, wherein the lock remains in the locking state when the real-time unlocking information inputted into the third smart mobile device does not match with the third preset unlocking information, wherein the lock switches to the unlocking state when the real-time unlocking information matches inputted into the third smart mobile device with the third preset unlocking information, wherein a countdown of an unlocking time of the lock is executed after the lock switches to the unlocking state, and wherein the lock switches back to the locking state after the countdown is over or the lock is opened.

8. The door access control method as claimed in claim 1, wherein when the report receiver does not respond to the report, the report is repeatedly sent to the report receiver, and wherein the reporting procedure is terminated when the report receiver responds to the report.

9. The door access control method as claimed in claim 8, wherein when the lock APP installed on the second smart mobile device executes the reporting procedure, the interface of the lock APP installed on the first smart mobile device shows a message associated with the report, and wherein the report receiver uses the interface of the lock APP installed on the first smart mobile device to respond to the report and to terminate the reporting procedure.

10. The door access control method as claimed in claim 1, wherein when the concerned user executes the emergency report and unlocking procedure via an interface of the lock APP installed on the second smart mobile device, the lock APP installed on the second smart mobile device is used to input a real-time unlocking information, wherein when the real-time unlocking information does not match with the first preset unlocking information, the lock remains in the locking state,
wherein when the real-time unlocking information matches with the first preset unlocking information, the second smart mobile device executes a reporting procedure to report to the manager, the lock is switched to the unlocking state and remains in the unlocking state, and wherein the lock restores the locking state after the lock is opened.

11. The door access control method as claimed in claim 5, wherein an interface of the lock APP installed on the first smart mobile device guides setting of a second preset unlocking information, wherein when the manager uses the interface of the lock APP installed on the first smart mobile device to execute a normal unlocking procedure, a real-time unlocking information is inputted into the second smart mobile device, wherein the lock remains in the locking state when the real-time unlocking information inputted into the first smart mobile device does not match with the second preset unlocking information, wherein the lock switches to the unlocking state when the real-time unlocking information inputted into the first smart mobile device matches with the second preset unlocking information, wherein a countdown of an unlocking time of the lock is executed after the lock switches to the unlocking state, and wherein the lock switches back to the locking state after the countdown is over or the lock is opened.

12. A door access control method comprising:
installing a lock APP on a first smart mobile device of a concerned user and setting a report receiver;
using the lock APP installed on the first smart mobile device to obtain management authority of the lock, permitting the first smart mobile device to execute an emergency report and unlocking procedure on the lock, with the concerned user wearing a wearable device which detects a physiological value of the concerned user, wherein the wearable device matches with and is connected with the first smart mobile device;
wherein when the lock APP installed on the first smart mobile device identifies the physiological value of the concerned user is normal, the first smart mobile device does not execute the emergency report and unlocking procedure, wherein when the lock APP installed on the first smart mobile device identifies the physiological value of the concerned user is abnormal, the first smart mobile device executes the emergency report and unlocking procedure and executes a reporting procedure sending a report to the report receiver, the lock switches to an unlocking state and remains in the unlocking state, and wherein the lock restores the locking state after the lock is opened.

13. The door access control method as claimed in claim 12, wherein the physiological value includes a blood oxygen level of the concerned user, wherein the lock APP installed on the first smart mobile device identifies the physiological value of the concerned user is abnormal when the blood oxygen level of the concerned user is lower than 80%, and wherein the lock APP installed on the first smart mobile device identifies the physiological value of the concerned user is normal when the blood oxygen level of the concerned user is not lower than 80%.

14. The door access control method as claimed in claim 12, wherein the physiological value includes a body temperature of the concerned user, wherein the lock APP installed on the first smart mobile device identifies the physiological value of the concerned user is abnormal when the body temperature of the concerned user is not lower than 41° C. or not higher than 35° C., and wherein the lock APP installed on the first smart mobile device identifies the physiological value of the concerned user is normal when the body temperature of the concerned user is 35° C.-41° C.

15. The door access control method as claimed in claim 12, wherein the physiological value includes a heart rate of the concerned user, wherein the lock APP installed on the first smart mobile device identifies the physiological value of the concerned user is abnormal when the heart rate of the concerned user is not higher than 30 beats per minute, and wherein the lock APP installed on the first smart mobile device identifies the physiological value of the concerned user is normal when the heart rate of the concerned user is higher than 30 beats per minute.

16. The door access control method as claimed in claim 12, wherein the lock APP installed on the first smart mobile device of the concerned user requests setting of a first preset unlocking information, wherein when the concerned user uses the interface of the lock APP installed on the first smart mobile device to execute a normal unlocking procedure, a real-time unlocking information is inputted into the first smart mobile device, wherein the lock remains in the locking state when the real-time unlocking information does not match with the first preset unlocking information, wherein the lock switches to the unlocking state when the real-time unlocking information matches with the first preset unlocking information, wherein a countdown of an unlocking time of the lock is executed after the lock switches to the unlocking state, and wherein the lock switches back to the locking state after the countdown is over or the lock is opened.

17. The door access control method as claimed in claim 12, wherein when the report receiver does not respond to the report, the report is repeatedly sent to the report receiver, and wherein the reporting procedure is terminated when the report receiver responds to the report.

18. The door access control method as claimed in claim 12, wherein the lock APP is installed on a second smart mobile device held by the report receiver, wherein when the concerned user executes the reporting procedure, a message of the report is displayed on an interface of the lock APP installed on the second smart mobile device, and wherein the report receiver responds to the report via the interface of the lock APP installed on the second smart mobile device to terminate the reporting procedure.

19. The door access control method as claimed in claim 18, with the report receiver using the lock APP installed on the second smart mobile device to register a username, with the concerned user using the username to set the report receiver and sending information of the setting of the report receiver to the lock APP installed on the second smart mobile device, and wherein the setting of the report receiver is successfully set only when the report receiver uses the lock APP installed on the second smart mobile device to accept the setting of the report receiver.

20. The door access control method as claimed in claim 12, wherein the lock APP installed on the first smart mobile device of the concerned user requests setting of a first preset unlocking information,
wherein when the concerned user executes the emergency report and unlocking procedure via an interface of the lock APP installed on the first smart mobile device, the lock APP installed on the first smart mobile device is used to input a real-time unlocking information, wherein when the real-time unlocking information does not match with the first preset unlocking information, the lock remains in the locking state,
wherein when the real-time unlocking information matches with the first preset unlocking information, the first smart mobile device executes a reporting procedure to report to the report receiver, the lock is switched to the unlocking state and remains in the unlocking state, and wherein the lock restores the locking state after the lock is opened.
